(19) United States
(12) Patent Application Publication
(10) Pub. No.: US 2011/0120441 A1
(43) Pub. Date: May 26, 2011

(54) WIRE SAWING DEVICE

(76) Inventor: Andreas Menzel, Jena (DE)

(21) Appl. No.: 13/001,679

(22) PCT Filed: Jun. 30, 2009
(86) PCT No.: PCT/EP2009/004727

§ 371 Date: Feb. 9, 2011

(30) Foreign Application Priority Data
Jun. 30, 2008 (DE) 102008030826.9

(51) Int. Cl. B28D 5/00

(52) U.S. Cl. 125/21

(57) ABSTRACT

The wire saw for sawing a work piece, e.g. to make silicon wafers for electronic applications, has two or more sawing fields (10, 20) each having a number of saw wires (11, 21) stretched between respective wire guiding cylinders (3, 4; 5, 6). The sawing fields are disposed one above the other. A first sawing field (10) includes deflection rollers (7) for deflecting slack sides (14) of its saw wires that face a second sawing field (20). The slack sides (14) of the saw wires of the first sawing field are guided over the deflection rollers (7) so as to deflect the saw wires and thus increase distances of their slack sides (14) to sawing sides (23) of the saw wires of the second sawing field (20).

The innovation relates to a wire sawing device according to the preamble of the independent claim.

Wire sawing devices of this type having a motion of the wire or wires, or of the workpiece to be sawed are already known, in particular in the industry for electronic components composed of ferrites, quartzes and silicon dioxides, for obtaining materials such as poly- or monocrystalline silicon or materials such as GaAs, InP, GGG or also quartz, artificial sapphire and ceramic materials in thin slices, i.e. wafers.

In the known devices, a sawing zone or a sawing field is formed using adjacent wires which are stretched e.g. using a set of at least two cylinders disposed in parallel. The cylinders comprise grooves which define the distance between the wires of the sawing field and, therefore, the thickness of the slices to be sawed. In this manner they also serve as wire guiding means. The workpiece to be sawed is fastened e.g. to a table which is displaced perpendicularly to the wire field or the sawing field formed of wires stretched in parallel, the speed of displacement defining the cutting speed. The means that perform the cutting are either a grinding means securely affixed to a wire (fixed grain) or a loose grinding means (loose grain) in the form of a slurry that adheres loosely to the wire. To saw the workpiece into thin slices, the stretched wires of the wire field are placed into the grooves of the cylinder or are drawn through these cylinders. The workpieces to be sawed, which are also referred to as ingots, blocks, or bricks, typically have the shape of a prism having a round, rectangular, square, or pseudo-square base surface. Elongated blocks having a rectangular or square cross section are typically used to manufacture solar wafers, for example.

Since, with saws of this type, and particularly in the manufacture of thin wafers, the diameter of the saw wire used defines the minimum loss of material, increasingly thinner wires are used to increase the number of wafers that can be obtained per kg of brick. Since the wires are also subject to wear during sawing, however, their diameter decreases with each pass. This wear greatly reduces the tear resistance of the saw wire over time. If such a thin saw wire does tear, the entire sawing process must be halted and the entire length or a portion of the entire length of the workpiece must be discarded. Due to the diminished tear resistance of the saw wire due to the thin diameter thereof or the additional wear thereof, either the sawing speed must be reduced or the width of the wire field must be kept smaller from the onset, thereby likewise reducing the load on the relatively expensive sawing device.

The technical problem addressed by the invention is therefore that of providing a wire sawing device that prevents the disadvantages described. The invention should be suitable in particular for thin wires i.e. wires having a diameter of ≦120 μm, in particular ≦100 μm. In particular, the wire sawing device should be suitable for wires having a diameter of up to 60 μm, and should permit the manufacture of solar wafers having an edge length of 6 to 8 inches.

The problem is solved by the subject matter of the independent claim. Advantageous developments are described in the dependent claims.

The innovative wire sawing device for sawing at least one workpiece, which is prismatic in particular, comprises a planar sawing or wire field formed of wires which extend next to one another but are separated from one another, wherein the wires of the sawing field are stretched between wire guiding means. Advantageously, a long wire is used, which, coming from a first wire accumulator, is wound up in the shape of a spiral around the wire guiding means and, after use, is drawn into a second wire accumulator. The wire sawing device comprises at least two sawing fields, wherein each sawing field typically comprises a preferably independent wire drive. The region that cuts the workpiece is referred to as the wire field, sawing zone, or sawing field. The device according to the invention comprises at least two such sawing fields which do not need to be spacially contiguous, however. Given that each of the sawing fields comprises a separate, independent wire drive, a wire guiding system, and a wire supply and removal system, the advantage results that the operation of one or more sawing fields can be interrupted, e.g. after the saw wire tears, while operation of the unaffected sawing fields can continue. Basically it is also possible to remove the destroyed wire, if necessary, during a short interruption. According to the invention it is therefore possible to limit the material loss to only a portion of the workpiece to be sawed with the torn wire field or, as already practiced today, to only a portion of this part.

A wire drive is understood to be a gearbox or a motor which drives the wire supply device and/or the wire take-up device and/or one or more wire guiding means coming from the wire accumulator. A plurality of output drive trains of a gearbox represent independent wire drives in the sense of the innovation if they can be switched on and off independently of one another, even if the gearbox is driven by a common motor. Preferably, the speed of the particular wire drives is controllable, thereby making it possible to saw various workpieces in the particular sawing fields at a respectively desired speed of the wire feed. The saw wire forming the sawing fields can be driven continuously or with an alternating direction of motion.

According to a preferred embodiment, the sawing and wire fields are each formed by a wire which is wound several times, i.e. in the form of a spiral, around a pair of wire guiding means. Using this embodiment, a continuous drive of the saw wire can be carried out particularly well. According to a further preferred embodiment of the innovation, each sawing field comprises a separate wire accumulator, using which separate saw wires can be continuously fed or supplied. Given that the saw wires of the particular sawing fields are not designed to be contiguous and are supplied or taken up by independent wire accumulators, it is possible to operate the individual sawing fields fully independently of one another.

It is possible to situate a plurality of adjacent sawing fields together in a plane, thereby making it possible to saw particularly long workpieces. According to a further likewise preferred embodiment of the device according to the invention, the sawing fields are disposed in planes interspaced in parallel, however. Placing the sawing fields in different planes makes it possible to better utilize an available space, which is particularly advantageous in the mass production of wafers in particular. According to a particularly preferred embodiment, the sawing fields are disposed one above the other and, in fact, in alignment, thereby enabling a plurality of workpieces to be sawed to be installed particularly easily and rapidly. The space available for the wire sawing device is utilized effectively and, advantageously, the space required by the innovative wire sawing device is minimized.

A preferred embodiment comprises at least one first sawing field having deflection rollers for deflecting the part of the sawing field, i.e. the side, that faces a second sawing field. When feeding workpieces into sawing fields disposed in adjacent planes, the returning, non-sawing wire fields or sides of the first sawing field are deflected such that more space is available for the workpieces to be supplied to the second sawing field, thereby making the device more compact overall and reducing the amount of space required.

In the case of the above-described deflection, it is possible e.g. to direct the returning, non-sawing sides of the sawing field outwardly around the second sawing field. Particularly preferably, the slack sides of the sawing field of a first sawing field are guided over deflection rollers, however, in a manner such that the distance of the slack side of the sawing field, i.e. the returning, non-sawing wire field on the back side or underside of the first sawing field, to the sawing sides of the sawing field of a second sawing field is increased In contrast, the distance of the slack sides to the associated sawing field sides (sawing field) in the first sawing field is reduced and, in fact, preferably just to the point where the workpieces to be sawed in the first sawing field can be accommodated.

According to a further advantageous embodiment, the deflection rollers are adjustable. It is thereby possible to adjust the particular sawing fields to different sizes of workpieces. In addition, the installation height of the sawing device is reduced, thereby making it possible to also install a plurality of sawing devices one above the other, if necessary.

According to a further preferred embodiment, at least the sawing sides of a sawing field are supported by a support roller, thereby making it possible to saw a larger number of workpieces per sawing field without the deflection of the sawing sides impairing the sawing result. The support roller contributes to the stabilization of the saw wire i.e. to the reduction of vibrations and/or deviations at a right angle to the running direction.

According to the wire sawing device according to the invention, the footprint can be reduced since the separate sawing fields are disposed one above the other. Likewise advantageous is the fact that only one capture basin and only one supply tank are required for a sawing or grinding means (sawing slurry), thereby resulting in further cost advantages and space reductions. Given a specified room size, the innovation according to the invention makes it possible to install more wire sawing devices, per ground area and room height, in a building than would be possible with a side-by-side configuration. In this manner it is possible to substantially increase the sawing output per building or ground area in a room. Moreover, the device according to the invention makes it possible to lower the costs for supplying elements, such as the supply and storage of sawing slurries, electrical power, supply vessels, coolants, etc., thereby helping to lower investment costs and operating costs per surface area of wafer that is cut.

The innovation is explained below in greater detail with reference to drawings. The embodiments are merely examples and do not limit the general idea behind the innovation.

In the drawings:

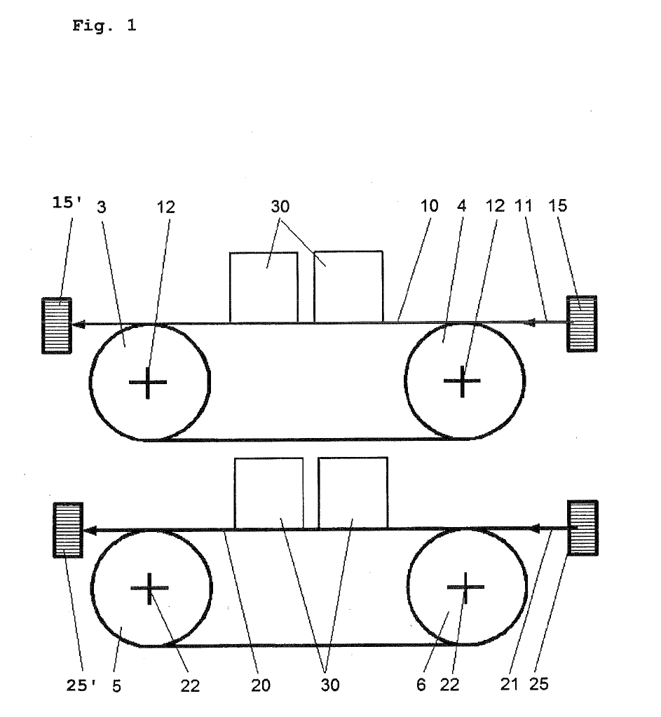

FIG. 1 shows a schematic depiction of a wire saw according to the invention;

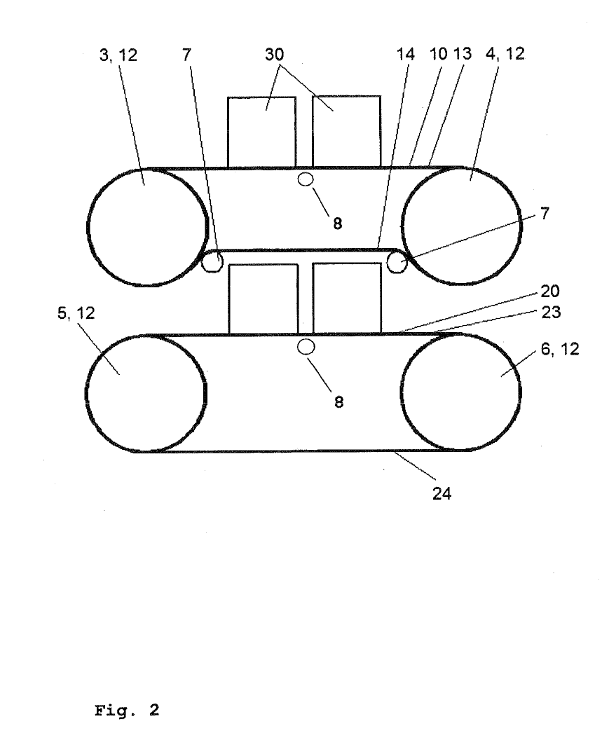

FIG. 2 shows a perspective depiction of a further embodiment of the wire sawing device according to the innovation;

As shown in FIGS. 1 and 2, the sawing device according to a first embodiment comprises a first sawing field 10 and a second sawing field 20, which are stretched around wire guiding cylinders 3 and 4, and 5 and 6, as wire guiding means, and each forming one pair. The cylinders have grooves which define the sawing distance. The axes of the wire guiding means or the cylinders are disposed in parallel and are installed on a not-shown machine frame, for example. The device can also comprise more than four wire guiding cylinders, of course. Wire guiding cylinders 3, 4, 5, 6 define, via the upper jacket lines thereof, the parallel planes of saw fields 10, 20. Separate saw wires 11, 21 are made available by wire accumulators 15 and 15′, 25 and 25′ shown in FIG. 1, wherein each wire accumulator in this case is composed of one take-off spool and one take-up spool, for example, the direction of the wire motion being indicated by arrows. The direction of the wire motion can be reversed, of course.

Independently operating wire drives 12, 22 of the first and the second sawing field 10, 20 are depicted schematically and comprise e.g. drive shafts of the wire guiding cylinders 3, 4, 5, 6. Grooves, which are not shown, are engraved in the periphery of wire guiding cylinders 3, 4, 5, 6 and define the distance between adjacent wires of particular sawing fields 10, 20 and, therefore, the thickness of the sawed slices. If a tear in the saw wire occurs in one of the sawing fields 10, 20, the arrangement of the sawing procedure according to the invention makes it possible to continue sawing in the respective other sawing field without delay.

Workpieces 30 to be sawed are fastened to a support which is not shown. Workpieces 30 to be sawed typically have an elongated prismatic shape with a round, square, pseudo-square, or rectangular base surface.

Separate saw wires 11, 21 are supplied from wire accumulators 15, 25 to wire guiding cylinders 12, 22, and are stretched between wire guiding cylinders 12/12 or 22/22, and are simultaneously guided and drawn. Saw wire 11, 21 is favorably composed of spring steel and has a diameter, for example, that is less than 200 um, preferably even smaller than 120 μm, and smaller than 100 μm. An advantageous lower limit is approximately 60 μm. Therefore, blocks 30 composed of hard materials or a special composition, in particular for the semiconductor industry and solar plants, or also ceramic materials such as silicon, ceramic, compounds of elements of groups III-V and II-VI, GGG (gadolinium gallium garnet), sapphire, etc., can be sawed into slices having an approximate thickness of 0.1 to 5 mm. The grinding means are a commercial product and can be present as diamond, silicon carbide, aluminum oxide, etc. in a form affixed to the wire or loosely in a fluid, as a slurry which is used as a delivery device for the grinding means particles.

FIG. 2 shows a schematic depiction of a very particularly preferred embodiment of the wire saw according to the invention, wherein elements having identical labels correspond to those in the previous figures. The regions of the saw wire of sawing fields 10, 20 which saw workpieces 30 are referred to as sawing sides 13, 23, and the returning, non-sawing regions are referred to as slack sides 14, 24. Slack sides 14 of first sawing field 10 are deflected using deflection rollers 7 in a manner such that the distance to sawing sides 23 of the second sawing field is increased. As a result, advantageously, more space is created for supplying workpieces 30 to second sawing field 20. If deflection rollers 7 are adjustable, then the arrangement according to the invention can be used in a particularly flexible manner for various sizes of workpieces.

A further embodiment of the innovative wire sawing device is shown in FIG. 2. Sawing field 10 is supported by a roller 8 to reduce the deflection of sawing side 13. Vibrations of the saw wire are also reduced as a result.

1-9. (canceled)

10. A wire saw for sawing at least one work piece (30), said wire saw comprising
at least two sawing fields (10, 20), each of said sawing fields having a plurality of saw wires (11, 21) stretched between wire guiding means (3, 4; 5, 6) and all independent wire drive (12, 22), said saw wires being situated equidistantally next to each other in each of said sawing fields;
wherein the sawing fields are disposed one above the other and comprise at least one first sawing field (10) including deflection rollers (7) for deflecting slack sides (14) of the saw wires of the first sawing field, said slack sides (14) facing a second sawing field (20); and
wherein said slack sides (14) of said saw wires of said first sawing field (10) are guided over said deflection rollers (7) so as to deflect said saw wires of said first sawing field and thus increase distances of said slack sides (14) of said saw wires of said first sawing field (10) to sawing sides (23) of the saw wires of said second sawing field (20).

11. The wire saw according to claim 10, wherein said sawing fields (10, 20) are each stretched by a pair of said wire guiding means.

12. The wire saw according to claim 10, wherein each of said sawing fields (10, 20) has an independent wire accumulator (15, 25) that continuously feeds respective separate ones of said saw wires (11,21).

13. The wire saw according to claim 10, wherein said sawing fields (10, 20) are disposed in planes interspaced in parallel.

14. The wire saw according to claim 10, wherein said deflection rollers (7) are adjustable.

15. The wire saw according to claim 10, wherein sawing sides (13) of said wires (11, 21) of at least one of said sawing fields are supported by a support roller (8).
